(19) United States
(12) Patent Application Publication
(10) Pub. No.: US 2004/0246660 A1
(43) Pub. Date: Dec. 9, 2004

(54) Electrolytic cell

(76) Inventors: James A. Patterson, Sarasota, FL (US); Charles E. Entenmann, Key Largo, FL (US); John A. Thompson, Nassau (BS)

Correspondence Address: Charles J. Prescott, P.A., Suite 115, 2033 Wood Street, Sarasota, FL, 34237, US

(21) Appl. No.: 10/861,043

(22) Filed: Jun. 4, 2004

Related U.S. Application Data
(60) Provisional application No. 60/475,999, filed on Jun. 5, 2003.

(51) Int. Cl. H01G 2/10

(52) U.S. Cl. 361/517

(57) ABSTRACT

An electrolytic cell and chamber for converting electric power into heat. The cell includes a non-conductive housing and a conductive end member sealingly positioned in and extending from each open end of the housing. The end members have spaced apart proximal end surfaces to define, in cooperation with said housing, a chamber. Catalytic particles comprising an admixture of (a) palladium or palladium black particles, (b) inert non-conductive particles and optionally (c) boron particles are closely packed into said chamber and against each proximal end. A longitudinal gas passage extends through each end member in gas communication with the chamber. Each gas passage is sealably closeable, one gas passage being connectable to a source of pressurized hydrogen (H₂) or deuterium (D₂) gas deliverable under pressure into the chamber. A distal end of each end member is connected to an electric power source whereby, when electric current flows through the end members and across the chamber which is filled with said catalytic particles and hydrogen or deuterium gas, heat is produced within the chamber for external use.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to energy conversion units producing heat from electrical current and more particularly to an electrolytic cell utilizing a gaseous electrolyte within a sealed chamber filled with packed palladium catalytic particles to produce heat by passing an electric current therethrough.

2. Description of Related Art

The utility of converting electric current into heat for external use is obvious and well known. Common electrolytic cells utilizing a water-based electrolyte wherein an electric current passes through the liquid electrolyte flowing through or held within the electrolytic cell to produce the chemical breakdown of water into hydrogen and oxygen and the production of heat as a byproduct is also well known.

The present invention provides a form of electrolytic cell utilizing a gaseous electrolyte in the form of hydrogen or deuterium gas and catalytic particles comprising active palladium particles combined with inert non-conductive particles such as diatomaceous earth or ceramic particles uniformly blended into an admixture with the palladium particles. The catalytic particle mixture is chambered within a non-conductive housing and compacted and held within the housing by conductive end members which are sealingly engaged within the preferably cylindrically configured non-conductive housing. By passing electrical current through the chamber containing the catalytic particles and hydrogen or deuterium gas, heat is produced for external use.

### BRIEF SUMMARY OF THE INVENTION

This invention is directed to an electrolytic cell for converting electric power into heat comprising a non-conductive housing and a conductive end member sealingly positioned in and extending from each open end of the housing. The end members have spaced apart proximal ends to define, in cooperation with said housing, a chamber. Catalytic particles comprising an admixture of palladium particles and inert non-conductive particles are closely packed into the chamber and against each proximal end. A longitudinal gas passage extends through each end member in gas communication with the chamber. Each gas passage is sealably closeable, one gas passage being connectable to a source of pressurized deuterium gas deliverable under pressure into the chamber to charge the catalytic particles. A distal end of each end member is connected to an electric power source whereby, when electric current flows through the end members and across the chamber which is filled with said catalytic particles and hydrogen or deuterium gas, heat is produced within the chamber for use external of the housing.

It is therefore an object of this invention to provide a heat producing gaseous electrolyte-spaced electrolytic cell.

It is yet another object of this invention is to produce a hydrogen or deuterium gas electrolyte activated electrolytic cell for producing heat for external use.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is a section view through an electrolytic cell in accordance with the present invention.

FIG. 2 is a graphic data display depicting external cell surface temperature versus electrical power input for the cell shown in FIG. 1 prior to and after charging with a gaseous electrolyte

FIG. 3 is a graphic data display for a family of electrolytic cells as shown in FIG. 1 showing the relationship between external surface temperature and power input for the uncharged and uncharged cell.

### DETAILED DESCRIPTION OF THE INVENTION

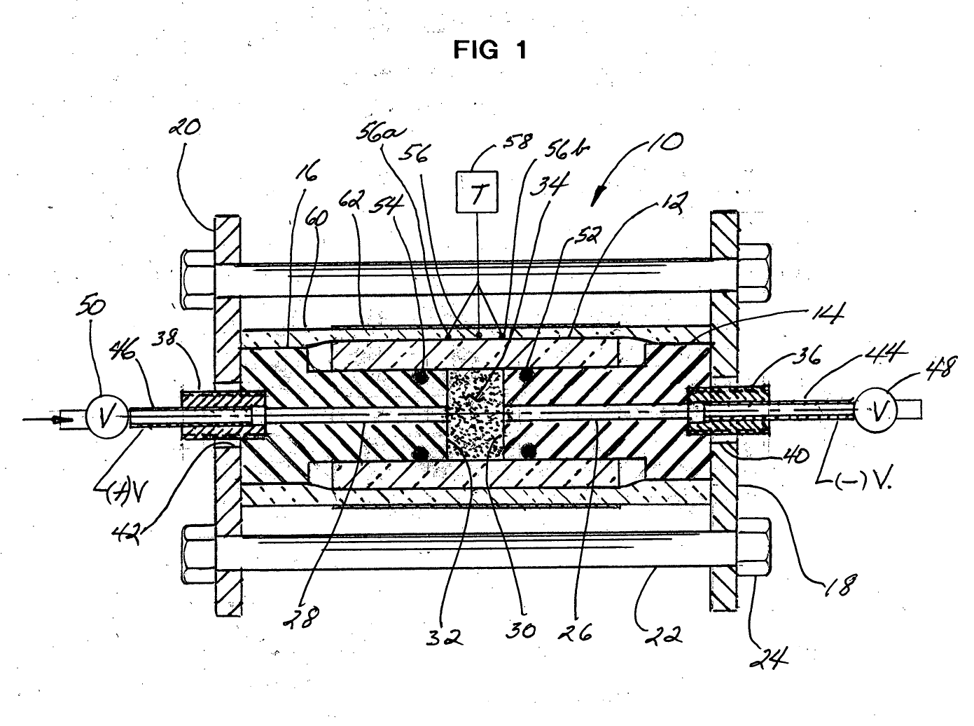

Referring now to FIG. 1, an electrolytic cell in accordance with the present invention is there shown generally at numeral 10. This cell 10 includes a non-conductive cylindrical housing shown generally at numeral 12 and open at each end thereof. This housing 12 is formed of vitreous lab-quality glass having a wall thickness of 2 mm, an outside diameter of 11 mm, and a length of 3 cm, producing a chamber volume of 7.63 cm³.

Conductive (preferably brass) end members 14 and 16 are fitted into each end of the housing 12 and are sealably engaged against the inside diameter of the tubular housing 12 by elastomeric O-rings 54. End plates 18 and 20 are positioned against the outer ends of each of the end members 14 and 16, respectively, and are held substantially parallel one to another and spaced apart by elongated threaded fasteners 22 which are spaced apart in a triangular or rectangular pattern as desired.

Conductive brass adaptors 36 and 38 are fitted into threaded engagement with mating apertures in each end of each end member 14 and 16, respectively. These adaptors 36 and 38 have a longitudinally extending aperture therethrough into which conductive tubular extensions 44 and 46 are sealably engaged and longitudinally extending therefrom as shown in FIG. 1. Each of the end members 14 and 16 further include a longitudinally extending passageway 26 and 28, respectively, which are each in fluid communication with the extension tubes 44 and 46, respectively.

Closely packed catalytic particles 34 are positioned between the proximal end faces of each of the end members 14 and 16. Details of the composition of these catalytic particles 34 and the method of compressing them are discussed herebelow.

A d.c. voltage source is applied during operation of the cell 10 between each of the conductive tubular extensions 44 and 46. The chamber which contains the catalytic particles 34 may be completely closed to atmosphere by valves 48 and 50 during calibration and operation of the cell 10 or may be opened to introduce the hydrogen or deuterium gas during charging of the cell 10. The charging process will be described more fully herebelow.

A thermocouple 56 is placed directly against the outer surface of the non-conductive housing 12 and in close proximity to the center of the catalytic particles 34. A temperature read out 58 is provided which will read the surface temperature of the housing 12.

A layer of insulation 60, although now not preferred, is wrapped around the housing 12 and the exposed outer surfaces of each of the end members 14 and 16 up to each of the end plates 18 and 20 as shown. This insulation 60 is held in place by at least one wrap of non-conductive tape 62 such as duct tape and is provided for more accurate and consistent temperature readings.

### Conductive Particles

The catalytic particles 34 are preferably formed from palladium crystals or palladium black as pure particle forms of palladium. Mixed uniformly with the palladium particles is either a powder form of diatomaceous earth or powdered ceramic material which increases electrical resistance.

Pd/DE Mixture

In preparing the palladium/diatomaceous earth (DE) form of the catalytic particles 2.5 grams of DE were placed in a clean crucible and heated to 800° c. A solution of Pd, Cl₂/Acetone was mixed and stirred with the DE to form a paste which was dried in a Bell jar over CaCl₂. This process of applying heat and stirring continued until a dry red-colored brick was obtained. The dried brick was then screened to dry powder having a uniform size of approximately 0.25 mm. Heat was then applied at 700° C. for approximately 24 hours. Thereafter, the mixture was placed in a hydrogen atmosphere furnace for approximately four hours at 320° C. The resultant particles were flushed with N₂ after cooling, after which the mixture was weighed. The above process was repeated until a weight of 12 grams was achieved. The mixture was then ground and screened through a 0.25 mm mesh screen.

Pd Black/Ceramic Mixture

Palladium black powder and a ceramic powder were mixed together with distilled water to make a paste. Mixing continues to eliminate all stratification of the two substances. Utilizing a vacuum pump and a suction device, the paste was suctioned until it formed a fine black powder. This process took approximately three hours depending on the capacity of the vacuum pump. This powder is describable as being delatency, i.e. one which, under stress, produces a mixture appearing as a solid; when the stress is relieved, it has a slight appearance of that of a liquid.

### Chamber Loading

Approximately 1 cc of one of the above-described catalytic particle mixture was loaded into the chamber formed between the proximate opposing faces 30 and 32 of each of the conductive end members 14 and 16 within the cylindrical housing 12. The catalytic particles 34 were placed within the chamber in several stages or layers totaling more than one and preferably five to ten layers. A small quantity (approximately ⅕ of the total of the catalytic particles) was placed into the chamber with the cylindrical housing 12 in an upright orientation and only one of the end members 14 or 16 in place. The conductive particles were tamped with a 1 kg load for approximately 2-5 minutes after each layer of the conductive particles were placed within the chamber. The total length of the chamber was approximately 10 mm.

After both end members 14 and 16 were in position and the end plates 18 and 20 held as shown in FIG. 1, slight tightening of the elongated threaded fasteners 22 at 24 was effected. This further compressed the conductive particles 34 and secured the end members 14 and 16 in proper positioning within the housing 12. A resistance of in the range of 10-150 ohms was targeted.

To insure a sealed chamber, approximately 100 p.s.i. of either hydrogen (H₂) or deuterium (D₂) gas was introduced into one of the tubular extensions 46 through valve 50 as shown by the arrow, while the other valve 48 was closed. The pressurized hydrogen or deuterium gas within the chamber was allowed to sit in the pressurized condition for approximately twenty-four hours.

Prior to pressurization or charging of the cell 10, a resistance curve between the conductive tubular extensions 44 and 46 was taken. A d.c. voltage was applied across these conductive tubular extensions 44 and 46 at atmospheric conditions to obtain a calibration curve of the conductive particles prior to hydrogen or deuterium charging. Table I herebelow shows a typical uncharged palladium/diatomaceous earth calibration data set showing the relationship between power input (watts in) and the surface temperature measured at 56 on the outer surface of the housing 12.

TABLE I
Uncharged Pd-Diatomaceous Earth Cell

| P (watts in) | T° C. |
|---|---|
| .0 | 17 |
| 0.8 | 38 |
| 4.3 | 71 |
| 6.7 | 85 |
| 20.0 | 160 |

Table II shows the calibration data set for another palladium/diatomaceous earth cell and a performance data set in terms of voltage, current, resistant temperature and power input of the charged cell in operation after it had been charged with pressurized deuterium gas overnight. Note that the cell is operated with deuterium or hydrogen gas within the chamber at atmospheric pressure rather than at the charging pressure of 100 p.s.i.

TABLE II
Pd-DE Cell

| | | | | | |
|---|---|---|---|---|---|
| Time | V | I | R | Temp | Watts |

Uncharged

| | | | | | | |
|---|---|---|---|---|---|---|
| 1520 | 5.1 | 0.071 | 72 | Ω | 36.2° C. | 0.36 |
| 1530 | 5.1 | 0.095 | 54 | Ω | 36.2° C. | 0.48 |
| 1540 | 5.1 | 0.114 | 45 | Ω | 38.7° C. | 0.58 |
| 1550 | 5.1 | 0.122 | 42 | Ω | 39.6° C. | 0.60 |
| 1600 | 15.0 | 0.127 | 40 | Ω | 40.3° C. | 0.60 |
| 1610 | 15.0 | 0.337 | 44.5 | Ω | 94.5° C. | 5.00 |
| 1617 | 15.0 | 0.295 | 50 | Ω | 96.5° C. | 4.40 |
| 1620 | 15.0 | 0.283 | 53 | Ω | 98.5° C. | 4.20 |

Charged Overnight

| | | | | | | |
|---|---|---|---|---|---|---|
| 0915 | 6.0 | 1.120 | 5.3 | Ω | 132.6° C. | 6.7 |
| 0925 | 6.0 | 10.84 | 5.5 | Ω | 132.6° C. | 6.5 |
| 0945 | 6.0 | 1.056 | 5.7 | Ω | 134° C. | 6.4 |
| 0950 | 6.8 | 1.174 | 5.7 | Ω | — | 8.0 |
| 1005 | 6.8 | 1.136 | 5.9 | Ω | 150.6° C. | 7.8 |
| 1030 | 7.8 | 1.270 | 6.1 | Ω | 155.3° C. | 9.9 |
| 1040 | 7.8 | 1.230 | 6.0 | Ω | 175.4° C. | 9.6 |
| 1048 | 8.3 | 1.270 | 6.5 | Ω | 184° C. | 10.5 |
| 1115 | 8.8 | 1.297 | 6.7 | Ω | 200° C. | 11.4 |
| 1125 | 8.8 | 1.280 | 6.8 | Ω | 205° C. | 11.3 |
| 1150 | 9.3 | 1.350 | 6.9 | Ω | 218° C. | 12.5 |
| 1203 | 10.0 | 1.350 | 7.3 | Ω | 227° C. | 13.4 |
| 1205 | 10.5 | 1.350 | 7.7 | Ω | 230° C. | 14.1 |
| 1207 | 10.8 | 1.380 | 7.8 | Ω | 251° C. | 15.0 |
| 1230 | 12.2 | 1.380 | 8.8 | Ω | 259° C. | 16.7 |
| 1245 | 16.9 | 1.370 | 12.3 | Ω | 306° C. | 23.1 |

Similar performance data of a charged palladium/ceramic cell is shown in Table III herebelow. Note that the cell was shut down for approximately two days and then restarted with the data continuing in continuous uninterrupted fashion.

TABLE III

| | | | | | |
|---|---|---|---|---|---|
| Time | V | I | R | Temp | Watts |

Charged Pd - Ceramic Cell

| | | | | | |
|---|---|---|---|---|---|
| 1255 | 8.70 | 0.65 | 13.3 Ω | 132.2° C. | 5.6 |
| 1410 | 3.00 | 1.94 | 1.5 Ω | 132.2° C. | 5.8 |
| 1420 | 3.05 | 1.94 | 1.3 Ω | 137.7° C. | 7.0 |
| 1454 | 3.00 | 2.30 | 1.3 Ω | 149° C. | 6.9 |
| 1500 | 3.40 | 2.31 | 1.5 Ω | 156.2° C. | 7.8 |
| 1527 | 3.00 | 2.30 | 1.3 Ω | 190° C. | 6.9 |
| 1540 | 2.46 | 2.61 | 0.9 Ω | 144° C. | 6.4 |
| 1615 | 5.65 | 2.61 | 2.0 Ω | 195° C. | 15.0 |
| 1625 | 5.34 | 2.61 | 2.0 Ω | 210° C. | 13.0 |
| 1630 | 5.09 | 2.61 | 1.9 Ω | 215.4° C. | 13.0 |
| 1640 | 5.16 | 2.61 | 1.9 Ω | 207° C. | 13.0 |

Shut Cell Down - Restarted 2 Days Later

| | | | | | | |
|---|---|---|---|---|---|---|
| 0930 | 14.6 | 0.325 | 45.1 Ω | temp. ↑ | 5.1 | w |
| 0950 | 9.93 | 0.71 | 14.0 Ω | 135.5° C. | 7.0 | |
| 1000 | 9.89 | 0.77 | 12.8 Ω | 150° C. | 7.6 | |
| 1005 | 9.86 | 0.91 | 10.8 Ω | 150° C. | 8.8 | |
| 1015 | 4.33 | 1.97 | 2.2 Ω | 162.0° C. | 8.7 | |
| 1040 | 4.48 | 1.96 | 2.2 Ω | 170° C. | 8.7 | |
| 1100 | 4.61 | 1.96 | 2.3 Ω | 172.6° C. | 9.0 | |
| 1120 | 4.76 | 1.95 | 2.4 Ω | 173.5° C. | 9.2 | |
| 1140 | 4.98 | 1.95 | 2.5 Ω | 180° C. | 9.7 | |
| 1210 | 5.06 | 1.94 | 2.6 Ω | 184.8° C. | 9.8 | |
| 1230 | 5.26 | 1.94 | 2.7 Ω | 183.9° C. | 10.2 | |

Diatomaceous Earth-Boron-Palladium Mixture

A mixture of 1.9 grams of diatomaceous earth in a form as previously described, in combination with 0.1 grams of elemental boron in granulated form is added to the diatomaceous earth before the addition of 6.8 grams of palladium chloride. The boron powder is added to facilitate operation of the cell and should have a particle size in the range of that previously described with respect to the diatomaceous earth.

In testing this cell with boron added, additional thermocouple readings were taken as seen in FIG. 1 at 56a and 56b. Thermocouple 56a is closer to the anode 46 while temperature reading at thermocouple 56b is taken closer to the cathode 44.

The calibration and testing of this cell is shown in Table IV herebelow. Four temperature readings are there shown wherein temperature A reflects the temperature taken at 56, temperature B is taken at thermocouple 56b, temperature C is taken at thermocouple 56a and temperature D represents an average of the three readings. although previous testing included a layers of insulation 60 and 62, the only insulation covering the three thermocouples 56, 56a and 56b was a layer of elastomeric bonding agent which covered and was adhered to only a small portion of the area of the cylindrical housing 12 covering the thermocouples.

TABLE IV
1.9 g DE/0.1 g Boron/6.8 g Palladium
Initial Starting Resistance - 90.7 ohms
UNCHARGED AT ATMOSPHERE

| | | | R | Temperature ° C. | | | | |
|---|---|---|---|---|---|---|---|---|
| Time | V | I | (Ohms) | A | B | C | D | Watts |
| 1040 | 0.39 | 2.829 | 0.14 | 44.9 | 45.1 | 42.0 | 44.3 | 1.10 |
| 1115 | 0.51 | 4.07 | 0.12 | | | | 57.2 | 2.07 |
| 1130 | 0.50 | 5.12 | 0.11 | | | | 69.1 | 3.02 |
| 1300 | 0.66 | 6.16 | 0.11 | | | | 82.9 | 4.06 |
| 1400 | 0.68 | 7.44 | 0.09 | | | | 95.4 | 5.06 |
| 1430 | 0.76 | 8.26 | 0.09 | | | | 109.0 | 6.28 |
| | | | | Temperature ° C. | | | | |
| Time | V | I | R | A | B | C | D | Watts |

CHARGED

| | | | | | | | | |
|---|---|---|---|---|---|---|---|---|
| 0850 | 1.74 | 2.590 | 0.67 | 94.6 | 97.3 | 86.2 | 92.7 | 4.51 |
| 0910 | 1.72 | 2.590 | 0.66 | 95.1 | 97.0 | 86.6 | 92.9 | 4.45 |
| 0940 | 1.71 | 2.591 | 0.66 | 94.7 | 97.5 | 87.0 | 93.1 | 4.43 |
| 1000 | 1.71 | 2.591 | 0.66 | 95.3 | 97.1 | 86.8 | 93.1 | 4.43 |
| 1115 | 1.72 | 2.594 | 0.66 | 97.6 | 99.7 | 89.4 | 95.6 | 4.46 |
| 1335 | 1.77 | 2.599 | 0.68 | 100.7 | 101.9 | 92.5 | 98.3 | 4.60 |
| 1400 | 1.77 | 2.600 | 0.68 | 101.1 | 102.6 | 93.4 | 99.0 | 4.60 |
| 1505 | 1.76 | 2.599 | 0.68 | 98.3 | 100.2 | 90.0 | 96.2 | 4.57 |
| 1600 | 1.75 | 2.596 | 0.67 | 97.7 | 99.6 | 89.4 | 95.6 | 4.54 |
| 1645 | 1.73 | 2.596 | 0.67 | 97.7 | 100.2 | 89.8 | 95.9 | 4.49 |

OVERNIGHT BREAK

| | | | | | | | | |
|---|---|---|---|---|---|---|---|---|
| 0845 | 1.73 | 2.585 | 0.67 | 96.4 | 98.1 | 87.1 | 93.9 | 4.00 |
| 0920 | 1.72 | 2.586 | 0.66 | 97.5 | 99.5 | 88.6 | 95.2 | 4.45 |
| 1000 | 1.71 | 2.588 | 0.66 | 98.3 | 100.9 | 90.1 | 96.4 | 4.42 |
| 1020 | 1.71 | 2.591 | 0.66 | 99.3 | 101.2 | 90.6 | 97.0 | 4.43 |
| 1040 | 1.70 | 2.591 | 0.65 | 99.3 | 101.3 | 90.5 | 97.0 | 4.41 |
| 1115 | 1.74 | 2.593 | 0.67 | 100.5 | 102.8 | 92.6 | 98.6 | 4.51 |
| 1120 | 1.74 | 2.593 | 0.67 | 101.3 | 103.4 | 92.9 | 99.2 | 4.51 |
| 1125 | 1.73 | 2.594 | 0.67 | 101.2 | 103.9 | 93.1 | 99.4 | 4.49 |
| 1135 | 1.82 | 2.595 | 0.70 | 103.3 | 105.1 | 94.5 | 100.9 | 4.72 |
| 1145 | 1.81 | 2.595 | 0.70 | 103.7 | 106.1 | 95.3 | 101.7 | 4.70 |
| 1150 | 1.81 | 2.555 | 0.70 | 104.5 | 106.6 | 95.6 | 102.2 | 4.70 |
| 1220 | 1.80 | 2.597 | 0.69 | 104.6 | 106.8 | 95.8 | 102.4 | 4.67 |
| 1255 | 1.80 | 2.597 | 0.69 | 105.3 | 107.4 | 95.9 | 102.9 | 4.67 |
| 1415 | 1.81 | 2.598 | 0.70 | 106.3 | 108.7 | 96.6 | 103.9 | 4.70 |
| 1520 | 1.83 | 2.596 | 0.70 | 105.3 | 107.9 | 95.0 | 102.7 | 4.75 |
| 1545 | 1.85 | 2.595 | 0.71 | 105.3 | 108.2 | 95.4 | 103.0 | 4.80 |
| 1610 | 1.86 | 2.595 | 0.71 | 106.0 | 108.3 | 95.4 | 103.2 | 4.80 |
| 0845 | 1.94 | 2.589 | 0.75 | 106.2 | 109.5 | 99.9 | 103.5 | 5.02 |
| 1035 | 1.99 | 2.591 | 0.77 | 106.7 | 109.8 | 96.9 | 104.5 | 5.16 |
| 1050 | 2.13 | 2.597 | 0.82 | 110.0 | 113.2 | 100.3 | 107.8 | 5.53 |
| 1315 | 2.13 | 2.613 | 0.81 | 114.1 | 117.7 | 103.0 | 111.6 | 5.56 |
| 1440 | 2.21 | 2.613 | 0.84 | 114.9 | 118.8 | 104.1 | 112.6 | 5.77 |
| 1500 | 2.21 | 2.613 | 0.84 | 116.3 | 119.6 | 104.6 | 113.5 | 5.77 |
| 1535 | 2.24 | 2.612 | 0.86 | 116.6 | 120.0 | 104.6 | 113.7 | 5.85 |

During each overnight break, operation of the cell continued at a reduced power input level sufficient to maintain the average temperature at approximately 60° C. It is noted that aluminum in place of boron was also tested but produced less favorable results leading to the conclusion that other periodic table group IIIA family members, i.e. gallium (Ga), indium (In) and thallium (Tl) may be equivalent.

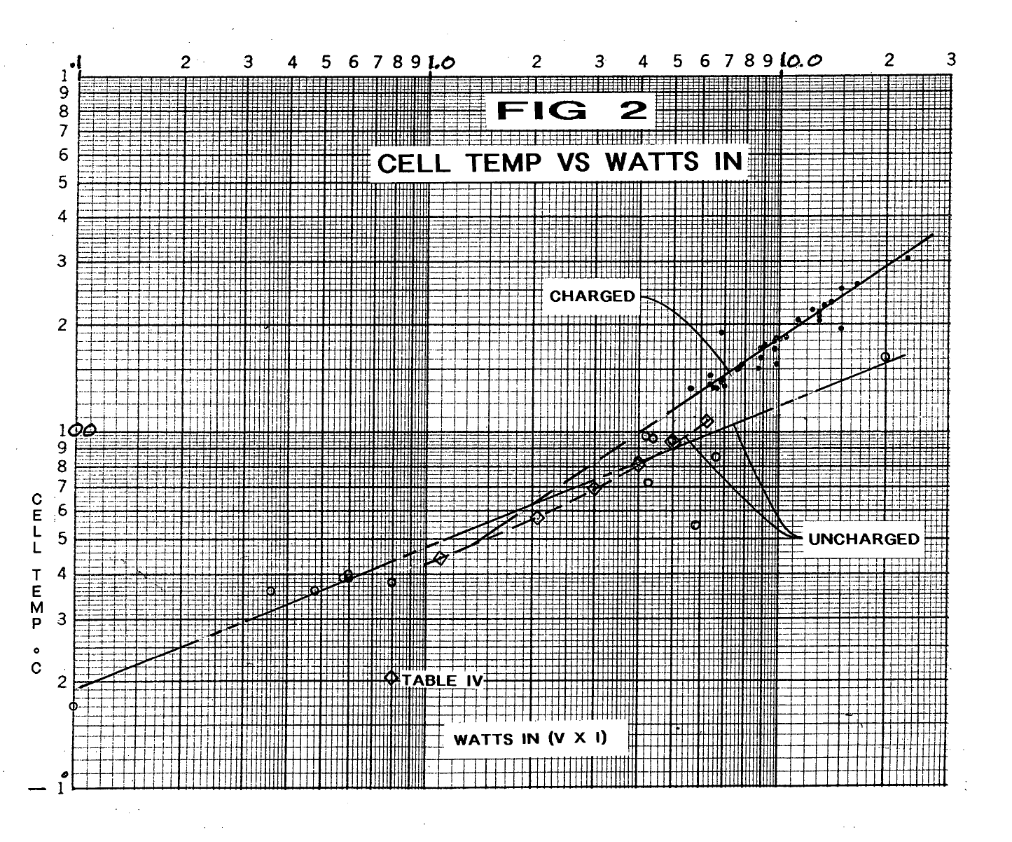

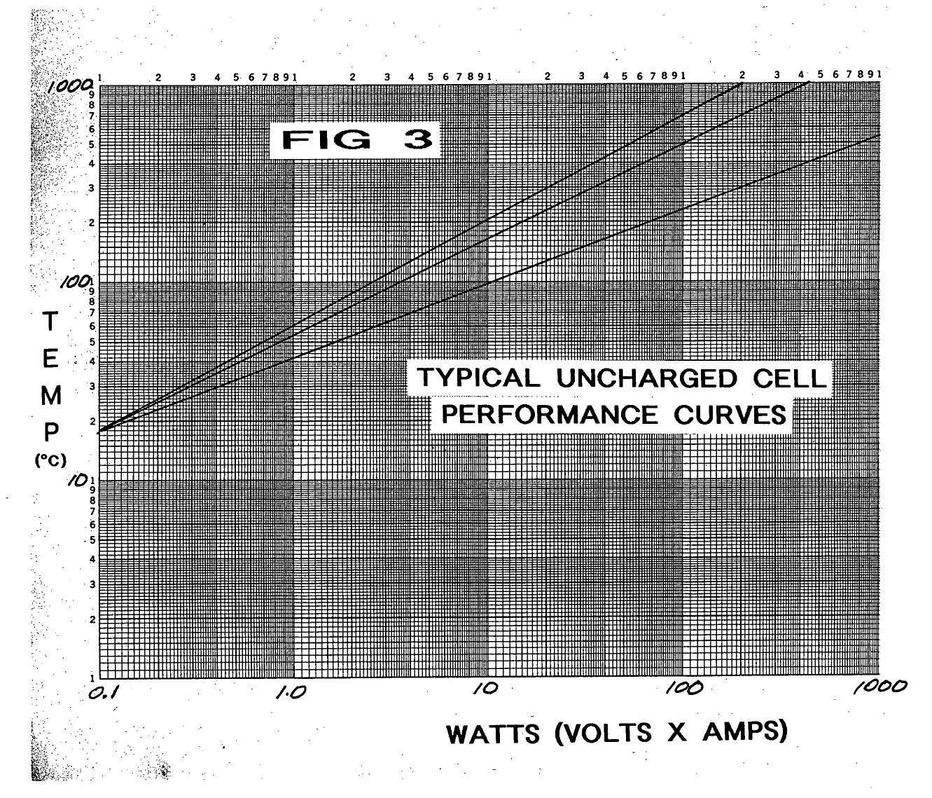

Referring now to FIGS. 2 and 3, a performance curve of the uncharged and charged cells with the catalytic particles contained therein is there shown. Note that there is a family of uncharged cell performance curves representing a variability in the overall resistance of the conductive particles, depending upon the degree of compaction and whether a ceramic or a diatomaceous earth non-conductive mixture was added to the palladium or palladium black particles. Note that the uncharged calibration of the boron cell shown in Table IV is compatible with calibration of the other cells reported hereinabove.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. An electrolytic cell comprising:
a non-conductive housing open at each end thereof;
a conductive end member sealingly positioned in and extending from each said open end of said housing, said end members having spaced apart proximal ends to define, in cooperation with said housing, a chamber therebetween;
catalytic particles closely packed into said chamber and against each said proximal end, said catalytic particles comprising a uniform mixture of palladium particles and inert non-conductive particles;
an end plate positioned against a distal end of each said end members, said end plates adjustably held together and against said distal ends whereby the length of said chamber and the degree of compression of said particles is adjustably established;
a longitudinal gas passage extending through each said end member in gas communication with said chamber, each of said gas passages being sealably closeable, one said gas passage being connectable to a source of pressurized hydrogen or deuterium gas deliverable under pressure into said chamber;
a distal end of each said end member being connectable to an electric power source whereby, when electric current flows through said end members and said chamber which is filled with said catalytic particles and said gas, heat is produced within said chamber proportional to electric current flow for use external of said housing.

2. An electrolytic cell comprising:
a non-conductive tubular housing open at each end thereof;
a conductive end member sealingly positioned in and extending from each said open end of said housing, said end members having spaced apart proximal ends to define a chamber therebetween;
catalytic particles closely packed into said chamber and against each said proximal end, said catalytic particles comprising a uniform mixture of palladium black powder and inert ceramic powder;
an end plate positioned against a distal end of each said end members, said end plates adjustably held together and against said distal ends whereby the length of said chamber and compacting force on said catalytic particles is adjustable;
a longitudinal gas passage extending through each said end member in gas communication with said chamber, each of said gas passages being sealably closeable, one said gas passage being connectable to a source of pressurized hydrogen or deuterium gas deliverable under pressure into said chamber;
a distal end of each said end member being connectable to an electric power source whereby, when electric current flows through said end members and said chamber which is filled with said catalytic particles and said gas, heat is produced within said chamber for use external of said housing.

3. An energy conversion apparatus for producing heat from electric power, comprising:
a chamber including non-conductive side walls and spaced apart electrically separated conductive end surfaces defining said chamber;
catalytic particles closely packed into said chamber and against each said conductive end surface, said catalytic particles comprising a uniform mixture of palladium or palladium black powder and inert non-conductive particles in a quantity sufficient to increase electrical resistance of said catalytic particles;
a longitudinal gas passage in gas communication with said chamber, said gas passage being connectable to a source of pressurized hydrogen (H₂) or deuterium (D₂) gas deliverable into said chamber for charging said conductive particles and for filling said chamber prior to operation of said apparatus;
each said end surface being connectable to an electric power source whereby, when electric current flows through said chamber, said catalytic particles and said gas, heat is produced within said chamber for external use.

4. An energy conversion apparatus for producing heat from electric power, comprising:
a chamber including non-conductive side walls and spaced apart electrically separated conductive end surfaces defining said chamber;
catalytic particles closely packed into said chamber and against each said conductive end surface, said catalytic particles comprising a uniform mixture of palladium or palladium black powder, boron powder and inert non-conductive particles in a quantity sufficient to increase electrical resistance of said catalytic particles;
a longitudinal closeable gas passage in gas communication with said chamber, said gas passage being connectable to a source of pressurized hydrogen (H₂) or deuterium (D₂) gas deliverable into said chamber for charging said conductive particles and for filling said chamber prior to operation of said apparatus;
each said end surface being connectable to an electric power source whereby, when electric current flows through said chamber, said catalytic particles and said gas, heat is produced within said chamber for external use.
